(19) United States
(12) Patent Application Publication
(10) Pub. No.: US 2013/0125430 A1
(43) Pub. Date: May 23, 2013

(54) IDENTIFICATION DEVICE AND METHOD FOR CONTAINERS

(71) Applicants: Mia M. Whittemore, El Dorado Hills, CA (US); Jo Dee Ross, El Dorado Hills, CA (US)

(72) Inventors: Mia M. Whittemore, El Dorado Hills, CA (US); Jo Dee Ross, El Dorado Hills, CA (US)

(21) Appl. No.: 13/684,120

(22) Filed: Nov. 21, 2012

Related U.S. Application Data
(60) Provisional application No. 61/629,677, filed on Nov. 23, 2011.

(51) Int. Cl. G09F 3/02

(52) U.S. Cl. CPC G09F 3/02
USPC 40/299.01; 264/510; 264/259; 264/138

(57) ABSTRACT

An identification device for a container such as a bottle, as well as a method for making the identification device, are disclosed that provide a convenient system for identification of a container. The identification device is generally cup shaped and includes a resilient inner lining that enables the device to be readily fixed releasably to the conventional container closure to cover over the container closure and to rotate with it. The identification device provides an identification function.

### RELATED APPLICATION

The present patent application claims priority to U.S. provisional patent applications, Ser. No. 61/629,677, filed Nov. 22, 2011 and incorporated herein by reference in its entirety as if fully set forth herein.

### FIELD OF THE INVENTION

The present invention relates in general to a container identification device and method, and it more particularly relates to the identification of a container, such as a water bottle or other, as being used by a certain person.

### BACKGROUND ART

There is no admission that the background art disclosed in this section legally constitutes prior art.

Water for drinking and other purposes was delivered in the past by way of large water bottles made of glass or plastic. Currently, smaller water bottles holding personal quantities of water for drinking have become ubiquitous. However, when many such water bottles are in one place, such as at a meeting, party, or other gathering, it is often difficult to identify which water bottle belongs to whom.

Efforts have been made in the past to provide ways to provide identification for particular bottles. For example, US Patent Publication No. 2009/0090688 discloses a color-coded bottle cap cover. The color-coded partial cover is used for a medicine bottle to help identify the medication contained within the bottle. The partial cover is in the form of an adhesive back band that is formed into a closed loop and then fixed to the bottle cap. However, the partial cover serves merely as an adjunct to an existing bottle cap, and by itself provides no protection for the contents of the bottle. Additionally, the partial cover must be assembled by the user, and such is time consuming and may be awkward for some. Thus, the device suffers from the drawback of being inconvenient to use.

U.S. Pat. No. 8,028,446 discloses a group of replacement beverage caps, each one of which has a different color or design element for identifying a bottle. The replacement caps are similar to conventional caps for plastic water bottles except that they have a different color or design on the outer surface. Each replacement cap contains internal integral threads to engage threadability the external threads on the neck portion of a water bottle. However, such a replacement cap has the disadvantage that there are a variety of different bottle neck external thread patterns, and thus there would have to be a variety of different such replacement caps to match exactly the variety of different thread patterns. This would require added manufacturing costs, since separate molds may well be required for each different thread pattern for different bottles. Also, different packaging may be required. Such added expense is undesirable for such a low cost product. It may well make it more difficult to associate the replacement cap with a particular bottle having matching threads.

Other identification techniques include U.S. Pat. No. 4,883,180 which discloses a color-coded cap which has a matching color for the label for a medicine bottle. However, the color coding appears to be intended to represent dosage frequencies, and thus, is not useful for identifying the owner of the bottle itself.

U.S. Design Patent No. 369,550, discloses a decorative tubular bottle cap cover, which is open at both ends and fits over the neck of the bottle. However, the same appears to provide no identification for the owner of the associated bottle.

### DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of an identification device and bottle system indicating a prior art closure and an identification device according to an embodiment.

FIG. 2 is an enlarged pictorial view of an underside of the identification device of FIG. 1.

FIG. 3 is a pictorial view of the identification device of FIG. 1, illustrating the identification device being pushed over the conventional closure or lid previously mounted to its bottle.

FIG. 4 is a pictorial view of an identification device of FIG. 1, illustrating it being removed from the conventional closure mounted to its bottle;

FIG. 5 is a side sectional view of the identification device, as mounted on a bottle illustrating an alternate mode of use where the identification device is mounted directly to the bottle instead of covering over the conventional closure;

FIG. 6 is an enlarged bottom sectional plan view of an identification device of FIG. 1;

FIG. 6A is a bottom sectional plan view of another identification device according to another embodiment;

FIG. 7 is a view similar to FIG. 5, except that it illustrates the preferred mode of use of the identification device of FIG. 1 as a cover fitting over the conventional closure for the conventional bottle.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of certain ones of the embodiments of the invention.

An identification device for a bottle or other container, as well as a method for making the device, are disclosed that provide a convenient system for bottle identification. The identification device includes a lining that allows a secure friction-fit for the identification device and yet can readily fit over the existing bottle closure to identify an open bottle, such as an open water bottle. The identification device provides an identification function for the consumer of the contents of the bottle.

According to another embodiment of the invention, there is disclosed an identification device for a bottle. The identification device may be generally cup shaped and includes a top wall and an annular skirt depending from the periphery of the top wall, the annular skirt defining an interior skirt wall. A resilient lining may be mounted on at least a portion of the interior skirt wall, such that the annular skirt and lining are structured and configured to frictionally engage and to cover over and rotate with the closure or cap provided with the bottle. The identification includes identifying indicia to help identify the user of the bottle or other container.

According to yet another embodiment of the invention, there is disclosed a method of making an identification device for a bottle. The method includes forming a top wall and forming an annular skirt such that the annular skirt depends from a periphery of the top wall. The annular skirt defines an interior skirt wall. The method further includes forming a resilient lining along at least a portion of the interior skirt wall, such that the annular skirt and the lining are structured and configured to frictionally engage and to cover over the conventional closure provided with the bottle or other container.

According to another aspect of an embodiment, the identification device resilient lining may enable the identification device to alternatively be attached releasably directly to a container, instead of fitting over a closure for the container.

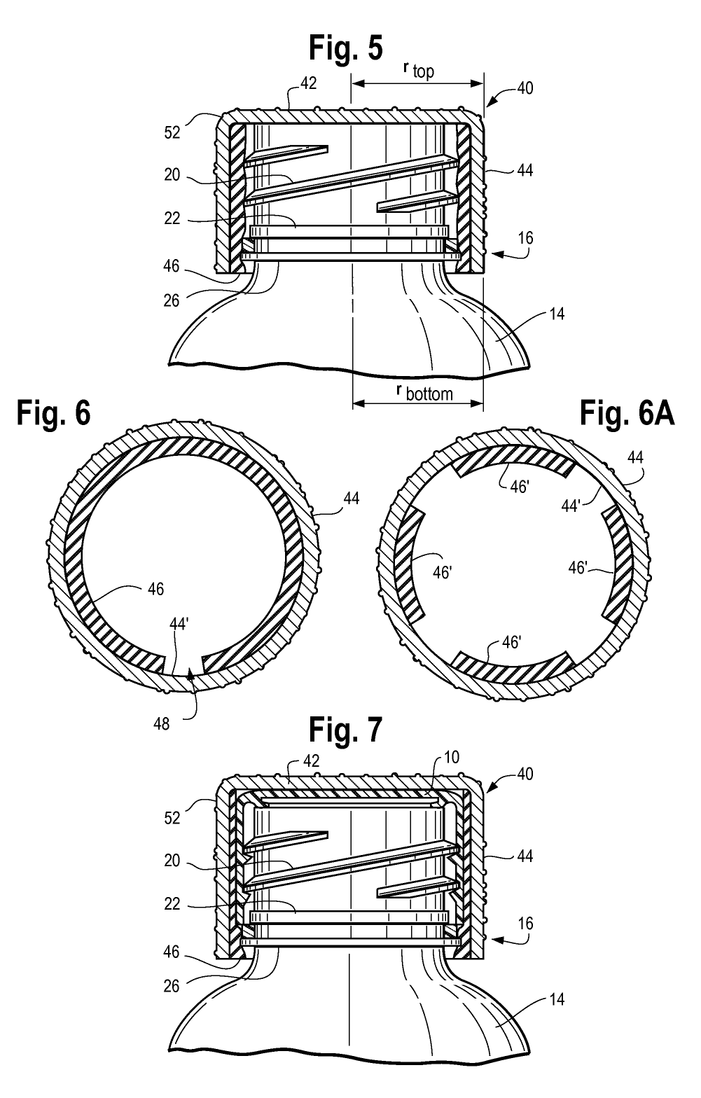

Referring now to the drawings, there is shown an identification device 40 which may be employed to cover and identify a bottle 12, having a bottle portion 14 and a neck portion 16, in accordance with an embodiment. The identification device 40 is intended preferably to fit over a conventional closure 10 provided with the bottle 12 (FIG. 7), or alternatively the device 40 may be used to replace the closure 10 (FIG. 5), which is conventionally mounted on the bottle 12 during manufacturing. The device includes identification indicia such a distinctive color, pattern, shape or design on the outer surface of the device 40, to enable the device 40 to identify the bottle 12.

The conventional closure 10 includes an annular wall 32 to which is mounted a ring 36. Within the interior of the closure 10 are one or more internal integral threads 34. The closure 10 may be removed from the bottle neck 16 by rotating the closure 10 with respect to the bottle in a direction indicated by arrows 28. As the closure 10 is removed from the bottle neck 16, the ring or rim 36, which is attached to a frangible ring 24 by a series of integral connectors, separates from the frangible ring 24, leaving the frangible ring 24 attached to the neck 16 of the bottle 12. In particular, and in addition referring to FIG. 7, the frangible ring 24 is disposed between a first annular lip 22 and a second annular lip 26. The first annular lip 22 is disposed below the one or more threads 20 of the bottle neck 16. It will be understood that other methods may be employed to maintain the frangible ring 24 on the neck 16 of the bottle 12.

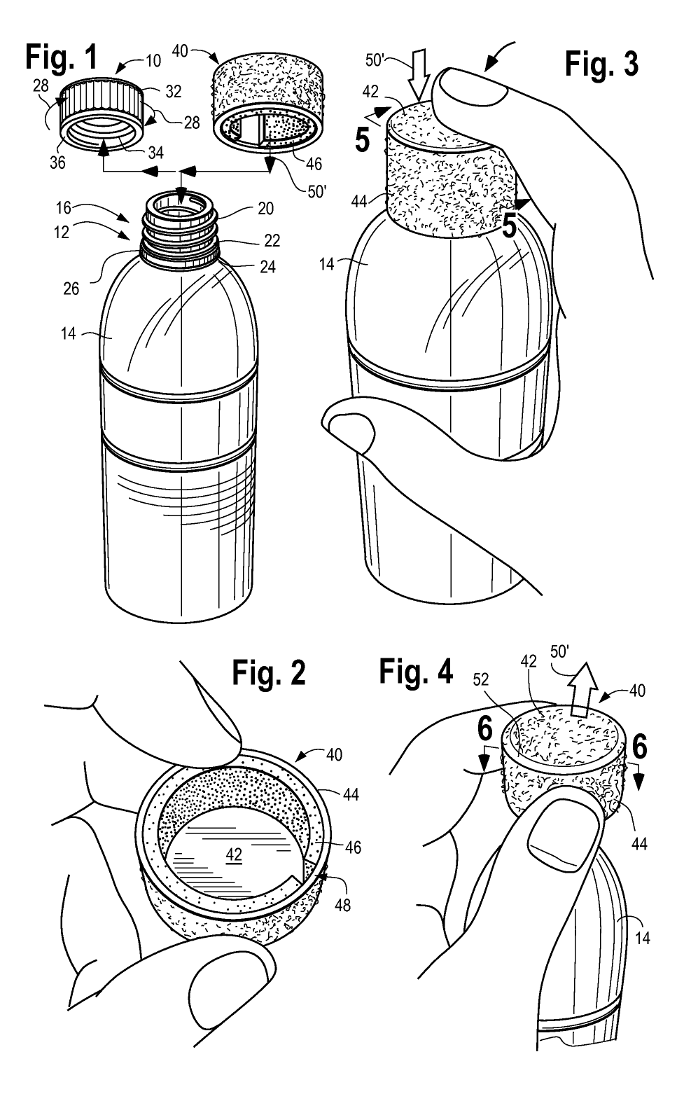

As may be seen in FIGS. 1, 2, and 7 especially, the identification device 40 is generally cup shaped and includes a top wall 42 and a depending annular skirt 44, which is preferably circular in cross section but other shapes may also be implemented. The annular skirt 44 depends from the periphery of the top wall 42. The annular skirt may depend from the top wall at a right angle, or in certain cases other angles may be employed as discussed below. The annular skirt 44 defines an interior skirt wall 44′. The identification device 40 further includes a resilient inner lining 46 mounted or formed on the interior skirt wall 44′. An exterior edge portion 52 of the intersection between the top wall 42 and the depending annular skirt 44 may be curved or rounded for ease in handling.

Referring to FIG. 6, it will be seen that the lining 46 mounted or formed on the interior skirt wall 44′ may include at least one resilient pad fixed to the interior skirt wall, and may have one or more gaps 48 defined therein or may encircle entirely the entire interior skirt wall without any gaps. Each resilient pad may have a variety of different sizes and shapes including, but not limited to, rectangular, square, round or other. Each resilient pad may be secured by means of a suitable adhesive or bonding to the interior skirt wall. Each resilient pad may be a rectangular, square, round or other adhesive backed strip. The gap 48 may provide certain manufacturing advantages as requirements for the tolerances of the lining vis-a-viz the skirt are significantly lessened. The number of such gaps may vary. While just one gap is illustrated in FIGS. 1, 2, and 6, in an alternative implementation, as shown in FIG. 6A, four gaps have been employed which separate four sections 46′ of the lining.

The lining 46 is in the form of a strip and is composed of a suitable resilient material, such, for example, as rubber, Neoprene, elastomeric materials or other resilient materials, including, but not limited to, soft polymers, foam or other.

Referring now to FIG. 7, there is shown the identification device 40 being used in the preferred mode as a covering on the conventional existing closure or cap. As shown in FIG. 7, the identification device fits over and frictionally engages the existing closure 10, which was previously separated from its frangible ring 24 (FIG. 1) and which is shown threaded onto the bottle neck 16. In this manner, the closure 10 can be grasped by manually gripping the outer identification device 40 to either thread or unthread the closure 10 onto or off of the bottle neck 16.

The resilient lining 46 may be suitably dimensioned in its thickness and in its resilience to accommodate both the bottle neck thread directly, and alternatively the closure 10 as a covering. However, it should be understood that those skilled in the art may adjust the thickness and resilience of the lining 46 to enable the identification device 40 to be used either as a replacement closure, or as a closure covering.

In one exemplary method of making the identification device 40, the top wall and annular depending skirt are formed in known manner, such as by injection molding, blow molding, extrusion, or the like. The lining may be formed in a separate step, for example, as a sheet, and then cut to size. The cut lining, which may include one or more lining sections, may then be mounted within the identification device, on the interior skirt wall. The mounting may include suitable adhesives, heat treatment, or the like. A decorative pattern or color may then be applied to the exterior of the identification device 40, to provide the identification functionality to identify this bottle with its users. Alternatively, the shape may provide such functionality, or the color may be integrated into the blown or molded material.

A method of one use of the identification device as a closure cover is illustrated in FIGS. 1, 3 and 4. In FIG. 3, once the closure 10 has been removed from and then later replaced threadably on the neck of the bottle 12 to cover over the mouth of the bottle 12, the identification device 40 may frictionally then engage directly and cover over the closure 10 mounted to the bottle 12. As shown in FIGS. 3 and 7, the user pushes or forces manually the identification device 40 in a direction indicated by the arrow 50′ according to one mode in which to use the identification device 40. In this manner, the device 40 is dimensioned and shaped to fit over completely and to obscure from view the closure 10. Once in place, the device 40 can be grasped by the fingers of the user as shown in FIG. 4 and rotated to remove the device 40 and the closure 10 from the bottle 12 as indicated by the arrow 50. In this regard, the resilient lining 46 is compressed in place between the inside of the annual device 40 and the outside of the closure 10 when the device is positioned over the closure as shown in FIG. 7 to provide a frictional engagement. In this manner, when the outer surface of the device 40 is grasped and rotated, the closure 10 rotates with the device 40 to thread or unthread the closure 10 relative to the bottle 12.

Removal of the identification device 40 from the closure 10 mounted threadably, to the bottle 12 is performed in an opposite manner to the attached method, by pulling or forcing manually the identification device 40 in a direction indicated by the arrow 50. Prior to removal, the identification device 40 is held onto the closure 10 threaded onto the bottle neck 16 in a manner indicated in FIG. 7. In particular, the lining 46 engages and grips frictionally the annular lip 26 on the bottle neck 16, and the closure 12 engages and grips the threads 20 on the bottle 12. In addition, the frangible ring 24 may also be engaged by the bottom portion of the resilient lining 46 as shown in FIG. 7. The frictional engagement of the lining 46 with the outer surface of the closure 10 causes the identification device 40 to be maintained in a secure position on the closure 10 until such time as a user intends to remove the device 40 from the closure 10.

As indicated above, the lining may be structured in a number of ways, including as a complete circumferential lining, as a broken circumferential lining having a single gap of width about ¼ inch, or as a broken lining having multiple gaps. The multiple gaps may be uniformly disposed about the interior of the closure, and may have a gap width of, for example, about ⅛ inch to about 1½ inches.

Referring now to FIG. 5, there is shown another mode of use of the identification device 40 as a replacement closure for the bottle 12. The resilient lining 46 enables the device 40 to serve as a replacement closure to serve as a decorative identifying device for the bottle 12. The lining 46 may be sufficiently thick to serve as a cover for the closure 10 as shown in FIG. 7, or alternatively as a replacement closure as shown in FIG. 5. In this regard, the lining 46 become significantly compressed when the device 40 covers over the closure 10 as shown in FIG. 7. When used alternatively as a replacement device as shown in FIG. 5, the lining 46 is relatively less compressed but is sufficiently so to engage the bottle external threads to grip them frictionally. Also, the resiliency of the lining 46 enables different external thread patterns of various different containers.

Without in any way limiting the foregoing, it is noted that in one implementation the following identification device specifications may be employed: rₜₒₚ of 1⅜ inches, with a slight curve on the top edges; r_{bottom} of 1 5/16 inches; height 13/16 inches; thickness of top wall and annular skirt 1/16 inch; and four lining sections with four gaps. Where the annular skirt and the top wall do not meet at right angles, rₜₒₚ will differ from r_{bottom}. Such differences resulting in angled device sides may be employed for a number of reasons. One reason is aesthetic. Another may be to allow ease of handling, e.g., the bottle may be grasped by the closure especially conveniently where rₜₒₚ exceeds r_{bottom}, i.e., where an acute angle is defined between the top wall and the annular skirt. On the other hand, where rₜₒₚ is less than r_{bottom}, i.e., where an obtuse angle is defined between the top wall and the annular skirt, the resulting closure may conveniently fit and be mounted on a wide variety of sizes of bottlenecks, because the neck may be inserted to the point within the identification device at which a friction fit is achieved. Different size necks will achieve a suitable frictional fit at different points within the identification device.

It should be understood that the devices and methods described and shown herein may be employed not only for water but for any liquid or other substance having a container requiring identification, e.g., juices, sodas, milk, and so on. Moreover, the devices and methods are not limited for use on plastic bottles: the device and method may be employed to close, cover and/or identify any type of bottle, including glass bottles such as beer bottles and others. In addition, to provide the identification function, it will be understood that the exterior of the closure may be styled in any number of colors and patterns, including stripes, polka dots, or the like. The same may be provided in a package enclosing a plurality of such closures, either with identical closures or an assortment.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. An identification device for a container having a closure, comprising:
a top wall;
an annular skirt depending from the periphery of the top wall, the annular skirt defining an interior skirt wall;
identifying indicia on the outer surface of the device;
a resilient lining mounted on at least a portion of the interior skirt wall,
the resilient lining including at least one resilient pad fixed to the interior skirt wall; and
wherein the annular skirt and lining are structured and configured to cover over and secure releasably and frictionally to the outer surface of the container closure.

2. The identification device of claim 1, wherein the annular skirt and lining are structured and configured to frictionally engage an annular lip on the neck of the container.

3. The identification device of claim 1, wherein the lining is made of a resilient material selected from one of the group consisting of rubber, Neoprene, elastomeric material, soft polymer and foam.

4. The identification device of claim 1, wherein the lining is mounted on the interior skirt wall along an entire circumference thereof.

5. The identification device of claim 1, wherein the lining is mounted on the interior skirt wall along an entire circumference thereof excepting a gap portion.

6. The identification device of claim 5, wherein the gap portion has an angular width of between about ⅛ inch and about 1½ inches.

7. The identification device of claim 1, wherein the lining is mounted on the interior skirt wall along an entire circumference thereof excepting at least two gap portions.

8. The identification device of claim 1, wherein the lining is mounted on the interior skirt wall along an entire circumference thereof excepting at least four gap portions.

9. The identification device of claim 1, wherein the shape of the resilient pad is substantially rectangular and is a strip.

10. The identification device of claim 9, wherein the resilient pad is a substantially square strip.

11. A method of making an identification device for a container having a closure, comprising:
forming a top wall;
forming an annular skirt such that the annular skirt depends from the periphery of the top wall, the annular skirt defining an interior skirt wall;
providing identifying indicia on the outer surface of the device; and
forming a resilient lining along at least a portion of the interior skirt wall, including fixing at least one resilient pad to the interior skirt wall;
such that the annular skirt and the lining are structured and configured to frictionally engage and cover over the closure provided with the container or, alternatively to engage releasably the neck of the container.

12. The method of claim 11, wherein the forming an annular skirt includes forming an annular skirt that depends from the top wall at about a right angle.

13. The method of claim 11, wherein the forming an annular skirt includes forming an annular skirt that depends from the top wall at about an acute angle.

14. The method of claim 11, wherein the forming an annular skirt includes forming an annular skirt that depends from the top wall at about an obtuse angle.

15. The method of claim 11, wherein the forming a lining includes forming a circumferential lining.

16. The method of claim 15, wherein the forming a lining includes forming a circumferential lining having one or more gaps defined therein.

17. The method of claim 11, wherein the forming includes blow or injection molding the top wall and the annular skirt.

18. The method of claim 11, wherein the lining is composed of resilient material selected from one of the group consisting of rubber, Neoprene, elastomeric material, soft polymer and foam.

19. The method of claim 11, wherein the lining is formed by cutting a strip of resilient material to a given length to fit the inside dimensions of the closure.

20. An identification device for a bottle having a closure, comprising:
a bottle identification device top wall having a depending skirt;
identification indicia on the outer surface of the device;
fixedly securing a strip of resilient material to the inside of the identification device depending skirt;
the strip of resilient material comprising at least one resilient pad;
each resilient pad being generally rectangular in shape; and
wherein each resilient pad is selected from the group consisting of rubber, Neoprene, elastomeric material, soft polymer and foam.
